(19) United States
(12) Patent Application Publication
(10) Pub. No.: US 2008/0154907 A1
(43) Pub. Date: Jun. 26, 2008

(54) INTELLIGENT DATA RETRIEVAL TECHNIQUES FOR SYNCHRONIZATION

(76) Inventors: Srikiran Prasad, Santa Clara, CA (US); Rik Sagar, Santa Clara, CA (US); Frank Judge, Haverhill, MA (US); Gurmeet Singh Kalra, Newark, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/615,660

(22) Filed: Dec. 22, 2006

(51) Int. Cl. G06F 17/30

(52) U.S. Cl. 707/10

(57) ABSTRACT

Data communication networks allow data, such as electronic documents, graphical images or audio files, to be retrieved from remote sources for use in local applications, such as synchronization environments. A device may store metadata useable to navigate and locate data stored on the remote source, and an application on the device may use the stored metadata to determine what data to retrieve from the remote server based on the currently accessed data. The metadata may comprise a portion of the data on the remote source that is displayed on the device while the data are being retrieved.

### BACKGROUND

The present invention relates to data networks, and more specifically to techniques for intelligently retrieving data from a remote source for use in applications such as synchronization environments.

Handheld devices and portable computers are becoming increasingly more powerful and functional devices. Many handheld devices are now multifunction devices with multiple device roles including: personal digital assistant (PDA), cellular phone, portable media player, voice recorder, video recorder, global positioning system (GPS), camera, and electronic file storage. Similarly, portable computers now have increased functionality and mobility. Because of these improvements in handheld devices and portable computers, these devices are increasingly used to access and modify data from multiple locations.

Additionally, advancements in both wireless Internet coverage and wireless network capabilities made a broad range of data, such as electronic files, image files, audio files and video files, accessible to mobile communication devices or portable computers. Network improvements have also allowed electronic data to be accessed from virtually all locations. Thus, the combination of improved wireless network access and improved portable device functionality has caused users to increasingly access electronic data from multiple, often widely separated, locations.

This widespread dissemination of information and increased access to information has created a need for a user, or multiple users, to access data from multiple devices. For example, a user may need to edit a particular file at one device and then, using a different device, access the same or a related file. Because portable computers and handheld devices have limited storage capacity, data are often stored on a remote server or other system with a large storage capacity. Thus, the necessary data must often be downloaded from the remote server before it is accessible to the user from a local device. Even where data storage capacity is not a major concern, data retrieval from a remote system is often performed to maintain synchronization of data that is accessible and modifiable from multiple devices.

Data downloads may also be initiated by a user, such as in the case of a request to play a song not stored on a local device. In areas with poor network connectivity or limited network access, a user-initiated data download increases the time needed for the user to access the requested data. Because the data are typically not downloaded until requested by the user, there may be a delay from the time the user requests the data until the user can access the data. When network resources are scarce, this time from data request to data access can be substantial. Further, the user must separately request all necessary data and wait for the requested data to be received.

Therefore, there is a need for more efficient techniques for retrieving data from a remote server, preferably without requiring an explicit user request before the data download can occur.

### SUMMARY

Using various embodiments of the invention, a device retrieves data from a remote server without requiring any explicit action by a device user. This allows data that are relevant to other data that has already been accessed to be automatically retrieved from the remote server. In particular, the retrieved data may comprise a file or media stream associated with or related to data currently or previously accessed or used by the device.

In one embodiment, the device initially receives metadata associated with data stored on a remote source, such as a data server. The received metadata comprises a subset of metadata stored on the remote server. Then, the received metadata are stored in a metadata store on the device. An application on the device accesses the stored metadata. Responsive to the metadata accessed, the application determines additional metadata, or data associated with the accessed metadata, to request from the remote server. The application then requests the determined data or metadata from the remote server. The device then receives the requested data or additional metadata. Received data may be stored in a data cache on the device, and received additional metadata may be stored in the metadata store on the device.

In one embodiment, responsive to the application's discontinuing access to the metadata, the request for additional metadata is canceled. This prevents the device from using network resources to receive data or metadata that will not be subsequently accessed by a device user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 is a block diagram of an architecture of the system, according to one embodiment of the invention.

FIG. 2 is a high-level block diagram of a device and a remote server, according to one embodiment of the invention.

FIG. 3 is a flow chart of a method for retrieving data from a remote server, according to one embodiment of the invention.

FIG. 4 is an example graphical user interface of an application for intelligently retrieving image files from a remote server, according to one embodiment of the invention.

FIG. 5 is an example graphical user interface of an application for intelligently retrieving electronic documents from a remote server, according to one embodiment of the invention.

FIG. 6 is an example graphical user interface of an application for intelligently retrieving audio files from a remote server, according to one embodiment of the invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

### DETAILED DESCRIPTION

Embodiments of the invention allow devices to use locally stored metadata to navigate and retrieve data from a remote server. The metadata contains information about content items expressed as digital data (e.g., where the data are song files, the metadata may include the corresponding song titles, artist information, and the like for navigating and requesting the song files). A user from a local device runs an application, which can display, play, or otherwise access data from the server. The user may use the application in a way that suggests that the user will need to access data that is not presently stored on the local device. Based on this use of the application, such as an access of certain data or metadata on the device, the application on the device determines the data or additional metadata that are likely to be later accessed. The application then requests this data or metadata from the remote server without requiring an explicit user request for that data or metadata. This expedites data retrieval from the remote server by allowing the application to begin retrieving relevant data or metadata predicatively. When the user later needs this data or additional metadata, the device will already have requested it from the remote server.

### System Architecture

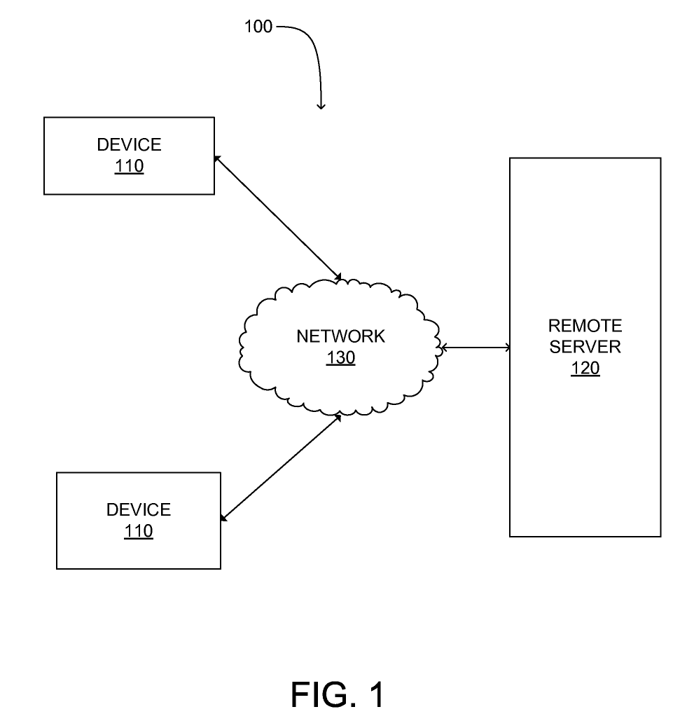

FIG. 1 illustrates one embodiment of a system 100 for retrieving data from a remote server 120. Although referred to herein as a server, the remote server 120 can be replaced with any other suitable source of data. Moreover, the server 120 is remote in the sense that it is not integral with the local device, but it may be physically located anywhere with respect to the local device (e.g., in the same room in a house and communicating over a Bluetooth connection, or across the world and communicating via the Internet). The system 100 comprises a remote server 120, a network 130, and one or more devices 110. The devices 110 use network 130 to access the remote server 120.

The devices 110 combine computing capabilities with data communication capabilities. For example, device 110 can be a tablet computer, a laptop computer, a portable digital assistant (PDA), a smartphone, or any device able to transmit and receive data and perform actions on data. In one embodiment, the device 110 comprises a desktop computer with data communication capabilities. In another embodiment, the device 110 comprises a mobile communication device that is structured to fit, and be controlled from, the palm of a hand while providing computing capabilities with wireless communication capabilities. Further embodiments of the device 110 are described in more detail below.

The remote server 120 contains information that can be used to identify and access the devices 110 connected to the network 130, such as Internet protocol (IP) addresses, or similar network addresses. The remote server 120 stores information, or data, that can be accessed by the devices 110. In an embodiment, the remote server 120 also separately stores metadata that describes the stored data. Further embodiments of the remote server 120, and the data and metadata storage capabilities of the remote server 120 are described in more detail below.

In one embodiment, in addition to the computing capabilities mentioned, a device 110 may also provide the functionality of the remote sever 120. This avoids having a separate, dedicated remote server 120 for this purpose. For example, a device 110, such as a laptop computer, may also act as the remote server 120 so that other devices 110, such as mobile communication devices and smartphones, can use the laptop computer to locate each other.

The network 130 is used to transmit information between the remote server 120 and a device 110, or multiple devices 110. In one embodiment, the network 130 comprises a conventional wireless data communication system, for example, general packet radio service (GPRS), IEEE 802.11 (or WiFi), IEEE 802.16 (or WiMax), Bluetooth, or any other suitable wireless communication system. In another embodiment, the network 130 comprises a conventional wired data communication system, such as Ethernet, digital subscriber line (DSL), integrated services digital network (ISDN), or any other suitable wired communication system.

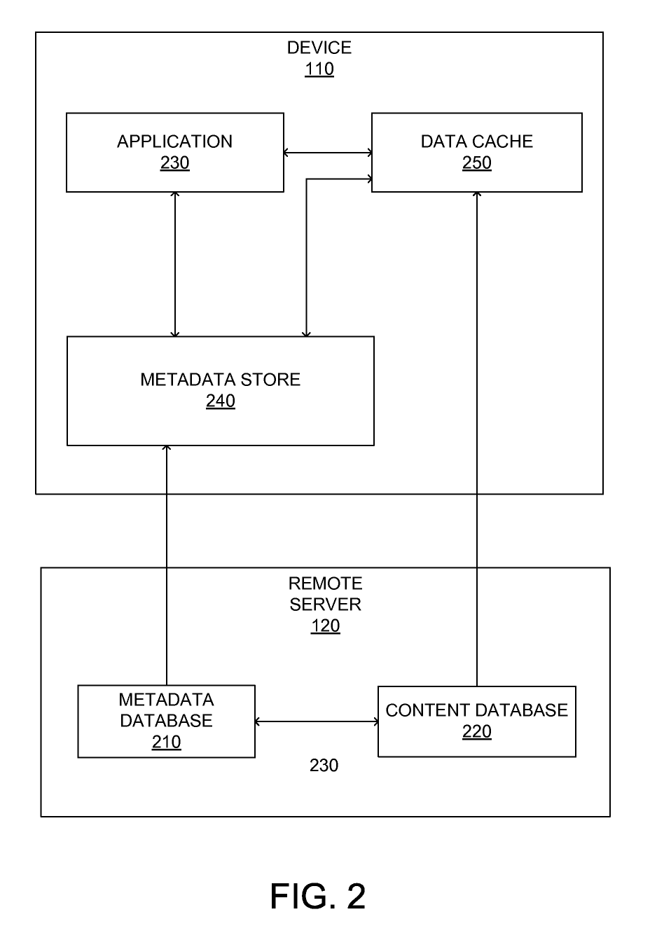

FIG. 2 is a block diagram illustrating the components of the device 110 and the remote server 120 according to one embodiment. As illustrated, remote server 120 comprises a content database 220 and a metadata database 210. The metadata database 210 comprises metadata that can be used to navigate and find content within the content database 220. In one embodiment, the metadata database 210 is stored separately from the content database 220. In another embodiment, the metadata 210 comprises a searchable field or fields of the content database 220 (such as the ID3 tags of MP3 song files). In an alternate embodiment, the metadata database 210 comprises descriptive tags stored within the content database 220 that describe the stored data. The metadata database 210 and the content database 220 can be stored using any configuration or data structure that associates the data within the content database 220 with the appropriate metadata and allows the data to be accessed using the metadata.

The information stored in the metadata database 210 may depend on the type of data stored in the content database 220. For example, when the data in the content database 220 comprise an audio file, the metadata database 210 may include information describing a title, a user-defined preference rating, the frequency the audio file has been played, or other information describing the audio file. Alternatively, when the data in the content database 220 comprise a graphical image, the metadata database 210 may contain information describing a storage date, a capture date, an association with a collection, a title, a thumbnail image or other information that describes the graphical image. If the content database 220 stores electronic documents, the metadata database 210 may comprise information describing a creation date, a modification date, a filename, a title, or other information describing the electronic document. The above description of data and metadata are merely examples, as the data can comprise any type of information and the metadata can comprise any information capable of describing or identifying the data.

Device 110 comprises an application 230, a metadata store 240, and a data cache 250. The application 230 presents metadata or data to a user and receives input from a user. Device 110 can include a visual display device, such as a liquid crystal display or cathode ray tube display, allowing the application 230 to present information to the user. Further, device 110 can include an input device, such as a keyboard, a digitizer pad, a “touch” sensitive display (e.g., pressure-sensitive (resistive), electrically-sensitive (capacitive), acoustically-sensitive (SAW, or surface acoustic wave), or photo-sensitive (infrared)) that allows the application 230 to receive input from the user.

The metadata store 240 receives and stores metadata from the remote server 120, which may be a subset of the metadata stored in the metadata database 210 or may include all the metadata stored in the metadata database 210. As new metadata are received from the remote server 120, the contents of the metadata store 240 are updated so the metadata store 240 contains the recently received metadata 210. The metadata store 240 can be a hard disk drive, a flash memory device, or some other mass storage device known in the art. Further, the metadata store 240 can be a volatile storage device, a non-volatile storage device, or a combination of a non-volatile storage device and a volatile storage device.

In one embodiment, the metadata store 240 is at least partially a non-volatile storage device. This allows certain metadata to be indefinitely stored, or “pinned,” in the metadata store. The pinned metadata can be manually selected by a user, or can be automatically pinned. In one embodiment, the metadata store 240 pins all metadata having a particular characteristic. For example, all metadata associated with a particular application, all metadata associated with a particular data type, or all metadata describing data created on a particular date can be pinned.

Application 230 interacts with the contents of the metadata store 240 and/or the contents of the data cache 250. The application 230 receives user input and accesses the metadata store 240 or data cache 250. In an embodiment, application 230 accesses metadata store 240 or data cache 250 in response to receiving user input. For example, a music player application may access the metadata database 210 to retrieve playlist information and then access the content database 220 to access songs on that playlist.

Additionally, the data cache 250 receives data from the remote server 120 and stores the data locally on the device 110. As data are received form the remote server 120, the contents of the data cache 250 are correspondingly updated. Thus, the data cache 250 contains the data recently downloaded from the remote server 120. Data contained in the data cache 250 can be rapidly accessed by application 230, or by the user of the device 110. The application 230 presents the received data or metadata to the user. For example, the application 230 can play audio files stored in the data cache 250, or the application 230 can display electronic documents or graphical images stored in the data cache 250. The data cache 250 can be a hard disk drive, a flash memory device, or some other mass storage device known in the art. Further, the data cache 250 can be a volatile storage device, a non-volatile storage device, or a combination of a non-volatile storage device and a volatile storage device.

Similar to the metadata store 240, in one embodiment the data cache 250 is at least partially a non-volatile storage device. This allows certain data to be permanently stored, or “pinned,” in the data cache 250. Data can be pinned in response to user-selection or may be automatically pinned. The pinned data remain stored in the data cache 250 until removed by the user. Even when new data are received from the remote server 120, the pinned data are not removed from the data cache 250.

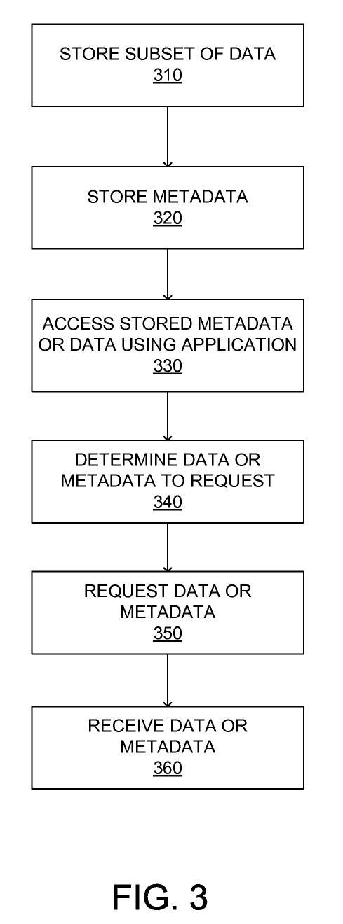

FIG. 3 is a flow chart illustrating the retrieval of data from a remote server 120 by a device 110, according to one embodiment. Those of skill in the art will recognize that other embodiments can perform the steps of FIG. 3 in different orders. Moreover, other embodiments can include different and/or additional steps than the ones described here.

Initially, the device 110 receives 310 a subset of the data stored on the remote server 120. This subset of data, representing some of the content available to the device 110, is then stored 320 in the data cache 250 on the device 110. The device 110 also receives metadata from the remote server 120 and stores 320 the metadata in the metadata store 240. The stored metadata describes at least some of the data stored on the remote sever 120 and thus can be used to navigate and locate data stored on the remote server 120.

The application 230 then accesses 330 the stored data or metadata, possibly in response to a user's use of the application. For example, the application 230 may access 330 the stored metadata to navigate and/or request data. Application 230 can access 330 the metadata store 240 or data cache 250 in multiple ways, such as selecting metadata or data, navigating between different metadata or data, deleting metadata or data, displaying metadata or data to the user, retrieving data corresponding to the metadata or any other operation that involves metadata or data. In an embodiment, metadata or data are accessed 330 in response to a user input. Based on the accessed 330 metadata or data, the application 230 determines 340 what additional metadata or data are likely to be used in the future.

After determining 340 relevant data or additional metadata to request form the remote server 120, the application 230 requests 350 those data or metadata. The device 110 then receives 360 the requested 350 data or metadata. This allows the application 230 to begin retrieving relevant data from the remote server 120 automatically and without requiring a previous user request therefor, thereby beginning retrieval of relevant data before the data are requested by the user and thus tending to obtain the data sooner. Depending on whether data or metadata are received 360, the received information can be stored in the data cache 250 or metadata store 240, respectively. By predicatively requesting 350 data or metadata, the application 230 requests 350 relevant data or metadata preferably before the data or metadata are actually needed by the user.

In an embodiment, the device 110 user can pin the initially received 310 subset of data, the initially received 320 metadata, or the later received 360 data or metadata 210. This causes indefinite storage of the data or metadata in either the data cache 250 or metadata store 240, respectively. In an alternative embodiment, attributes of the received data or metadata cause the information to be automatically pinned. For example, data created or modified on a particular date may be automatically pinned, allowing a user to access the pinned data from the local device 110 rather than first accessing the remote server 120.

In one embodiment, as the application 230 accesses 330 the metadata store 240, the application 230 determines 340 the additional metadata or data needed from the remote server 120. This determination 340 allows the application 230 to automatically request 350 additional metadata or data from the remote server 120 likely to be accessed by the user. Thus, the device 110 automatically requests 350 the data or metadata likely to be subsequently accessed by the application 230.

The application 230 is able to function, or partially function, without receiving all of the data or metadata from the remote sever 120. In one embodiment, the application 230 presents to the user a placeholder instead of unreceived data or metadata. Once the appropriate data or metadata are received it replaces the presented placeholder. Thus, the application 230 permits the user to access or navigate the contents of the metadata store 240 even when the metadata store 240 does not contain all the information used by the application 230.

For example, the data stored on remote server 120 may comprise graphical images and the metadata may describe the graphical images. In one embodiment, the metadata describes a storage time of the graphical image, a collection to which the graphical image belongs, a capture time of the graphical image, or any other information that can describe the graphical image. A collection of graphical images may be an album, a folder containing the images, or some other grouping of images. Once the application 230 accesses 330 metadata describing the graphical image, the application determines 340 the metadata describing other graphical images likely to be accessed. For example, the application 230 determines 340 it is likely that metadata or data describing graphical images with similar capture times or storage times will be later accessed so the user can browse through the graphical images. Thus, the application 230 requests 350 data from the remote server 120 corresponding to metadata indicating a similar capture time or storage time.

Alternatively, the collection associated with the graphical image may be an ordered album, and the application 230 determines 340 it is likely that metadata or data describing graphical images with similar collection associations (e.g., graphical images stored in the collection adjacent to the graphical images) will be later accessed so the user can browse through the collection. When the collection comprises an ordered album, the application 230 may determine that graphical images stored within a defined section of the collection are most likely to be accessed. Thus, the application 230 requests 350 data from the remote server 120 corresponding to metadata indicating a similar collection association. The additional graphical images are requested before being selected by the user, reducing the time from user selection to photograph display.

In an embodiment, the application 230 determines 340 which data or metadata to request based on the data or metadata currently accessed 330 by the application 230. The application 230 requests 350 data or metadata with characteristics similar to the currently accessed 330 data. As it is likely a user will access 330 similar types of data while using the application 230, data or metadata similar to the currently accessed 330 data are requested 350. For example, when the data comprise graphical images, the application 230 determines 340 that graphical images with similar storage times or creation times are likely to be accessed and requests 350 graphical images with similar storage times or creation times. For example, when the data comprise electronic documents, the application 230 determines 340 that electronic documents with similar modification dates or the recent modification dates are likely to be accessed, and the application 230 thus requests 350 those electronic documents. Alternatively, when the data comprise audio files, the application 230 determines that audio files with similar user-ratings, collection associations, or playlist designations are likely to be accessed and requests 350 those audio files.

In another embodiment, the application 230 works in conjunction with a software agent or data retrieval module that determines 340 the data or metadata likely to be later accessed based on the currently accessed data or metadata. Thus, the software agent or data retrieval module accesses 330 the data cache 250 or metadata store 240 and communicates the accessed 330 data or metadata to the application 230. Based on the accessed 330 data or metadata, the software agent or data retrieval module determines 340 data or metadata to request from the remote server 120 and requests 350 the data or metadata. Accordingly, the application 230 may only present data or metadata to the user and receive user inputs, while the data retrieval module or software agent accesses 330 the data or metadata and determines 340 the additional data or metadata to request 350.

### Example Applications

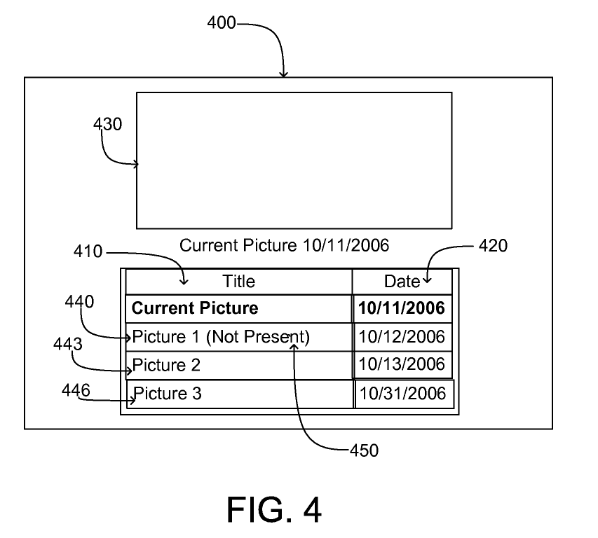

FIG. 4 illustrates an example graphical user interface of an application 400 configured to display and browse graphical images retrieved from a remote server 120, according to one embodiment. The remote server 120 stores data comprising graphical images and metadata describing the graphical images. The metadata may comprise a storage date, a creation date, an image capture date, a thumbnail image, an association with a collection, or any information capable of describing different graphical images. On the device 110, the metadata store 240 contains metadata describing at least a subset of the image files stored on the remote server 120. In the example of FIG. 4, the metadata comprise an image title 410 and a storage date 420.

In an embodiment, the application 400 uses the contents of the metadata store 240 to display a list of accessible images. For example, the application 400 displays a listing of the image titles 410 and the storage date 420 showing the accessible images. In addition to the metadata listing, the application 400 displays the complete image 430 selected by the user. The complete image displayed 430 is stored locally in the data cache 250.

Based on the accessed 330 metadata 210 and currently displayed image 420, the application 400 determines 340 other image files likely to be accessed 330. For example, the application 400 can determine 340 that other image files with similar storage dates 420 are likely to be later accessed because users typically browse through the image files chronologically. Thus, data or metadata corresponding to image files with similar storage dates 420 are requested 350 from the remote server 120. In other embodiments, data or metadata describing image files with capture dates or modification dates 520 within a defined range around the capture date of the currently displayed image 420, or related collection associations are requested 340, as they are more likely to be subsequently requested by a user who is browsing a particular image or collection. In other embodiments, when the collection comprises an ordered album, graphical images within a defined section of the collection, the section containing the user-selected image 430, are requested to allow the user to browse through the collection.

In FIG. 4, because data or metadata associated with image files having a storage date 420 similar to the displayed image 430 have been determined 340 to be later needed, the application 400 requests 340 data or metadata associated with picture 1 440, picture 2 443, and picture 3 446. For example, the application 400 may request metadata in the form of thumbnail images or data in the form of the complete pictures.

In one embodiment, when an image file incompletely stored in the data cache 250 or metadata store 240 is selected by the user, the application 400 skips that image file and accesses the next completely stored image file. However, the data or metadata corresponding to the skipped image file continues to be downloaded by application 400. In one embodiment, application 400 displays to the user an indication 450, such as a textual message or a graphical image, that the data or metadata needed for a graphical image has not been received 360. For example, the indication 450 informs the user that the data comprising picture 1 440 has not been completely received 360 from the remote device 120. However, because picture 2 443, and picture 3 446 are stored in the data cache 250, they can be accessed while picture 1 440 is being downloaded. Thus, the application 400 remains functional even when data still needs to be received 360.

In an embodiment, when the user selects a different graphical image, the current data and metadata 210 requests 350 are discontinued. Because the data or metadata determined 340 to be relevant (or otherwise likely to be requested) depends on the currently accessed data, changes in the data accessed 330 may modify the determination results. In the example of FIG. 4, once a different image is displayed, the application 400 may discontinue receipt 360 of picture 1 440, picture 2 443, and picture 3 446. Instead, the application 400 may determine 340 and request 350 data or metadata relevant to the newly displayed image. Thus, the application 400 need not continue receiving 360 data or metadata not likely to be subsequently used. Similarly, when the user terminates the application 230, the pending requests 350 for data or metadata are discontinued.

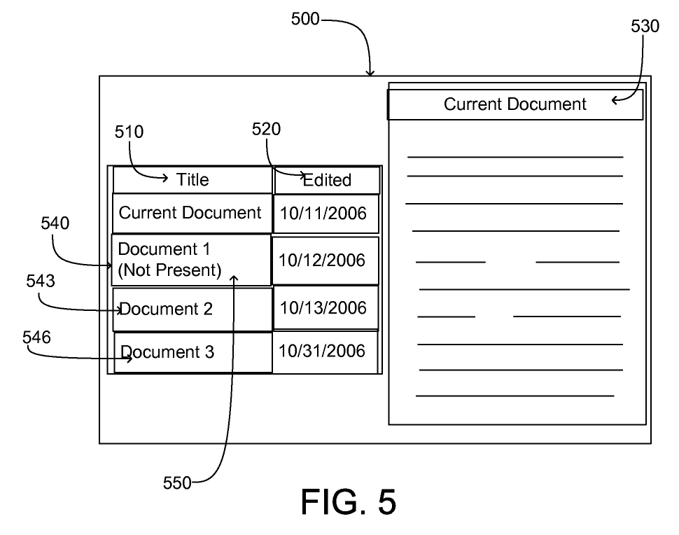

FIG. 5 illustrates an example graphical user interface of an application 500 configured to display and browse electronic documents retrieved from a remote server 120, according to one embodiment. The remote server 120 stores data comprising electronic documents, and metadata describing the stored electronic documents. The metadata may include a creation date, a modification date, a filename, and any information capable of describing different electronic documents. The electronic documents may comprise text files, spreadsheets, e-mails, calendar entries, contact information, or any other electronic file with at least some textual content. On the device 110, the metadata store 240 contains metadata describing at least a subset of the electronic documents stored on the remote server 120. In the example of FIG. 4, the metadata 210 comprises a filename 510 and a modification date 520.

In an embodiment, the application 500 uses the contents of the metadata store 240 to display a list of accessible electronic documents. For example, the application 500 displays a listing of the filenames 510 and the modification date 520 showing the accessible electronic documents. In addition to the metadata listing, the application 500 displays the user-selected electronic document 530, which is stored in the data cache 250.

Based on the accessed 330 metadata and user-selected electronic document 530, the application 500 determines 340 other electronic documents likely to be accessed. For example, the application 500 can determine 340 that other electronic documents with similar modification dates 520 will be later accessed because it is likely that the user will access electronic documents edited at a similar time. Alternatively, the application 500 can determine 340 that other electronic documents with the recent modification dates 520 will be later accessed because it is likely the user will access recently edited documents. Thus, data or metadata corresponding to electronic documents with similar modification dates 520, or the recent modification dates 520, are requested 350 from the remote server 120. In other embodiments, data or metadata describing electronic documents with similar filenames 510 or creation dates are likely to be later used and are requested 350. In different embodiments, the application 500 can use different criteria to determine 340 the applicable data or metadata, and accordingly request 350 different data or metadata from the remote server 120.

For example, the application 500 may determine 340 that electronic documents that have been modified within a specified time-frame of the modification date 520 of the user-selected electronic document 530 are likely to be accessed, and may request 350 the appropriate data or metadata. Alternatively, the application 500 may determine 340 that electronic documents that have been recently modified, that is electronic documents that have a modification date 520 within a certain time interval from the current date, are likely to be accessed, and requests 350 the electronic documents.

In FIG. 5, because data or metadata associated with electronic documents having a modification date 520 similar to the displayed electronic document 530 have been determined 340 likely to be later needed, the application 500 requests 350 document 1 540, document 2 543, and document 3 546, or requests metadata associated therewith. When an electronic document incompletely stored in the data cache 250 or metadata store 240 is selected by the user, the application 230 skips that electronic document and accesses the next electronic document completely stored in the data cache 250 or metadata store 240. However, the data or metadata corresponding to the skipped electronic document is still downloaded by application 500.

In one embodiment, application 500 displays an indication 550 to the user, such as a textual message or a graphical image, that data or metadata have not been received 360. For example, the indication 550 informs the user that the data comprising document 1 540 is not stored in the data cache 250. However, because document 2 543 and document 3 546 are stored in the data cache 250, they can be accessed while document 1 540 is being downloaded. Thus, the application 500 continues to function without receiving 360 all data or metadata that can be used.

In an embodiment, when the user selects a different electronic document, the current data and metadata requests 350 are discontinued. Because the data or metadata determined 340 to be relevant depends on the currently accessed electronic document, as the user-selected electronic document 530 changes, the determination 340 is modified. In the example of FIG. 5, changing the displayed electronic document 530 discontinues receipt 360 of document 1 440, document 2 443, and document 3 446. The application 230 determines 340 and requests 350 data or metadata relevant to the newly selected electronic document. Thus, the application 500 only receives 360 data or metadata likely to be subsequently used. Similarly, when the user terminates the application 500, the pending requests 350 for data or metadata are discontinued.

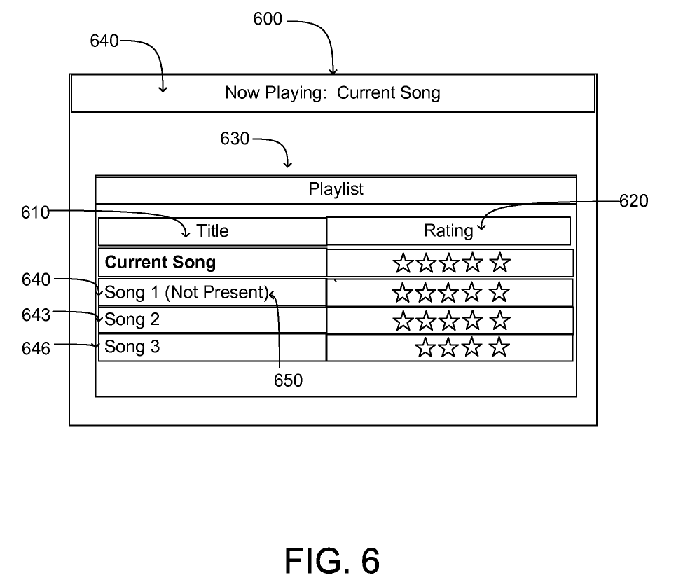

FIG. 6 illustrates an example graphical user interface of an application 600 configured to play audio files retrieved from a remote server 120, according to one embodiment. The remote server 120 stores data comprising audio files, and metadata describing audio files. The metadata may include a user-defined rating, a frequency of play, an association with a collection, a song title, or any information capable of describing different audio files. On the device 110, the metadata store 240 contains metadata describing at least a subset of the audio files stored on the remote server 120. In the example of FIG. 6, the metadata comprise a song title 610 and a user-defined rating 620. In one embodiment, the user-defined rating 620 is a star-listing indicating a user preference for each audio file.

In an embodiment, the application 600 constructs a playlist 630 that uses the metadata contained in the metadata store 240, and the application 600 displays the playlist 630. For example, the application 600 displays a listing of the song title 610 and the user-defined rating 620 as the playlist 630. The application 600 also displays the currently playing 640 audio file, which is locally stored in the data cache 250.

Based on the currently accessed 330 metadata (such as the playlist 630 in this example), the application 600 determines 340 other audio files likely to be accessed 330. For example, the application 600 can determine 340 that other audio files with user-defined ratings 620 similar to the currently playing 640 audio file are likely to be later accessed. This causes the application 600 to request 340 data or metadata describing the audio files with similar user-defined ratings 620. In other embodiments, the application 600 determines 340 that data or metadata describing audio files with similar frequencies of play or similar album associations are likely to be subsequently accessed 330, and the application 600 then requests 340 the appropriate data or metadata. In another embodiment, the application 600 determines 340 that audio files with high user ratings are likely to be subsequently accessed 330 and requests the appropriate data or metadata based thereon. In other embodiments, when the collection comprises an album, audio files within a defined section of the collection, the defined section including the currently playing 640 audio file is requested, thereby allowing the user to listen sequentially to the audio files in the collection.

In FIG. 6, because the currently playing 640 audio file has a user-defined rating 620 of five stars, the application 600 may determine 340 that other audio files with five-star user-defined ratings 620 are likely to be subsequently accessed. The application 600 may thus request 340 song 1 640, song 2 643, and song 3 646, or it may request additional metadata associated therewith (e.g., the first portion of the song, thereby allowing immediate playback while the application 600 obtains the complete song file).

When the application 600 reaches an audio file whose data or metadata are not stored on the device 110, the application 600 may skip immediate playback of that audio file while requesting the audio file from the remote server 120. The application 600 then proceeds through the playlist until it reaches a completely stored audio file. The application may check back later to see if any skipped audio files have been received and then play those audio files for the user. This allows the application 600 to play currently stored audio files while downloading other audio files and later playing the newly downloaded audio files.

In one embodiment, application 600 displays to the user an indication 650, such as a textual message or a graphical image, that the necessary data or metadata has not been received 360. For example, the indication 650 informs the user that the data comprising song 1 640 is not been completely stored in the data cache 250. However, the application 600 continues to play audio files stored in the data cache 250, such as song 2 643 and song 3 646 without receiving 360 the complete data corresponding to song 1 640. Thus, song 1 640 can be downloaded from the remote server 120 while song 2 643 and song 3 646 are playing.

In an embodiment, when the user selects a different audio file or stops playback of the playlist, any pending data and metadata requests are discontinued. Because the data or metadata determined 340 to be relevant may depend on the currently access audio file, as the selected audio file changes, the determination 340 may also change. In the example of FIG. 6, selecting a different audio file may discontinue receipt 360 of song 1 640, song 2 643, and song 3 646. For example, the application 600 may request all of the songs in an album when a user plays the first song, but then discontinue the request if the user stops the song and plays another. The application 600 may again determine 340 and request 350 data or metadata relevant to a newly selected audio file. Thus, the application 600 may only receive 360 data or metadata that is likely to be later used. Similarly, when the user terminates the application 600, the pending requests 350 for data or metadata are discontinued.

The above description provides examples of possible applications 400, 500, 600 for purposes of illustration only. The invention need not be limited for use with these specifically described applications 400, 500, 600 and can be applied to a variety of data types in a variety of ways.

### SUMMARY

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memory (ROM), random access memory (RAM), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

What is claimed is:

1. A method for managing retrieval of data by a local device from a remote source, the method comprising:
storing on the local device a subset of the data stored on the remote source;
storing metadata on the local device, the metadata usable to navigate and locate data stored on the remote source;
accessing at least one of the data and the metadata by an application on the local device;
responsive to the accessing by the application on the local device, determining additional data or metadata to request from the remote source; and
requesting the additional data or metadata from the remote source.

2. The method of claim 1, further comprising:
responsive to the accessing by the application on the local device, determining additional data or metadata to request from the remote source; and
requesting the additional data or metadata from the remote source.

3. The method of claim 1, further comprising:
discontinuing the accessing; and
responsive to the discontinuing, canceling the request for additional data or metadata from the remote source.

4. The method of claim 1, further comprising:
displaying the stored metadata to a user while the additional data or metadata are requested from the remote source.

5. The method of claim 1, wherein the stored metadata comprise searchable fields of the data.

6. The method of claim 1, further comprising:
responsive to requesting the additional data or metadata, displaying metadata stored on the local device associated with the additional data or metadata.

7. The method of claim 1, further comprising:
responsive to a request to access a second set of additional data or metadata not stored on the local device, requesting the second set of additional data or metadata from the remote source; and
accessing data stored on the local device that is related to the second set of additional data or metadata until the second set of additional data or metadata is obtained by the local device.

8. The method of claim 1, further comprising:
responsive to a request to access data or metadata not stored on the local device, displaying information indicating the requested data or metadata are not stored on the local device.

9. The method of claim 1, wherein the data requested from the remote source comprise graphical images.

10. The method of claim 9, wherein the metadata associated with the graphical images comprise an attribute selected from a group consisting of: a creation date, a storage date, a title, and an association with a collection; and wherein determining additional graphical images or metadata to request from the remote source is based at least in part on the attributes associated therewith.

11. The method of claim 9, wherein the graphical images are part of an ordered collection, and determining additional graphical images to request from the remote source is based at least in part on comparing the proximity in the ordered collection of the additional graphical images to one or more of the accessed graphical images.

12. The method of claim 10, wherein determining additional graphical images to request from the remote source is based at least in part on comparing a collection associated with the additional graphical images to a collection associated with one or more accessed graphical images.

13. The method of claim 1, wherein the data stored on the remote source comprise electronic documents.

14. The method of claim 13, wherein the metadata associated with the electronic documents comprise an attribute selected from a group consisting of: a modification date, a creation date, and a filename; and wherein determining additional electronic documents or metadata to request from the remote source is based at least in part on the attributes associated therewith.

15. The method of claim 14, wherein determining additional electronic documents to request from the remote source is based at least in part on comparing the modification date of the additional electronic documents to the modification date of one or more accessed electronic documents.

16. The method of claim 14, wherein determining additional electronic documents to request from the remote source comprises selecting one or more additional electronic documents that have a recent modification date.

17. The method of claim 1, wherein the data stored on the remote source comprise audio files.

18. The method of claim 17, wherein the metadata associated with the audio files comprises an attribute selected from a group consisting of: a rating, a play count, a title, an association with a collection, and a playlist designation; and wherein determining additional audio files or metadata to request from the remote source is based at least in part on the attributes associated therewith.

19. The method of claim 18, wherein determining additional audio files to request from the remote source comprises selecting one or more additional audio files that have a highest rating.

20. The method of claim 18, wherein determining additional audio files to request from the remote source comprises selecting one or more additional audio files that have a highest frequency of play.

21. The method of claim 18, wherein the audio files are part of an ordered collection, and determining additional audio files to request from the remote source is based at least in part on comparing the proximity of one or more of the additional audio files in the collection to one or more accessed audio files.

22. The method of claim 18, wherein the audio files are part of a playlist, and determining additional audio files to request from the remote source comprises selecting additional audio files from the playlist that are adjacent to one or more accessed audio files.

23. A computer program product for managing retrieval of data by a local device from a remote source, the computer program product comprising a computer-readable medium containing computer program code for:
storing on the local device a subset of the data stored on the remote source;
storing metadata on the local device, the metadata useable to navigate and locate data stored on the remote source;
accessing at least one of the data and the metadata by an application on the local device;
responsive to the accessing by the application on the local device, determining additional data or metadata to request from the remote source; and
requesting the additional data or metadata from the remote source.

24. The computer program product of claim 23, further comprising:
responsive to the accessing by the application on the local device, determining additional metadata or data to request from the remote source; and
requesting the additional data or metadata from the remote source.

25. The computer program product of claim 23, further comprising:
responsive to the application discontinuing access to the stored metadata, canceling the request for additional data or metadata from the remote source.

26. The computer program product of claim 23, further comprising:
displaying the stored metadata to a user while the additional data or metadata are requested form the remote source.

27. The computer program product of claim 23, wherein the stored metadata comprise searchable fields of the data.

28. The computer program product of claim 23, further comprising:
responsive to requesting the additional data or metadata, displaying metadata stored on the local device associated with the additional data.

29. The computer program product of claim 23, further comprising:
responsive to a request to access a second set of additional data or metadata not stored on the local device, requesting the second set of additional data or metadata from the remote source; and
accessing data stored on the local device that is related to the second set of additional data or metadata until the second set of additional data or metadata is obtained by the local device.

30. The computer program product of claim 23, further comprising;
responsive to a request to access data not stored on the local device, displaying information indicating the requested data or metadata are not stored on the local device.

31. The computer program product of claim 23, wherein the data requested from the remote source comprise graphical images.

32. The computer program product of claim 31, wherein the metadata associated with the graphical images comprise an attribute selected from a group consisting of: a creation date, a storage date, a title, and an association with a collection; and wherein determining additional graphical images or metadata to request from the remote source is based at least in part on the attributes associated therewith.

33. The computer program product of claim 31, wherein the graphical images are part of an ordered collection, and determining additional graphical images to request from the remote source is based at least in part on comparing the proximity in the ordered collection of the additional graphical images to one or more of the accessed graphical images.

34. The computer program product of claim 32, wherein determining additional graphical images to request from the remote source is based at least in part on comparing a collection associated with the additional graphical images to a collection associated with one or more accessed graphical images.

35. The computer program product of claim 23, wherein the data stored on the remote source comprise electronic documents.

36. The computer program product of claim 35, wherein the metadata associated with the electronic documents comprise an attribute selected from a group consisting of: a modification date, a creation date, and a filename; and wherein determining additional electronic documents or metadata to request from the remote source is based at least in part on the attributes associated therewith.

37. The computer program product of claim 36, wherein determining additional electronic documents to request from the remote source is based at least in part on comparing the modification date of the additional electronic documents to the modification date of one or more accessed electronic documents.

38. The computer program product of claim 36, wherein determining additional electronic documents to request from the remote source comprises selecting one or more additional electronic documents that have a recent modification date.

39. The computer program product of claim 23, wherein the data stored on the remote source comprise audio files.

40. The computer program product of claim 39, wherein the metadata associated with the audio files comprises an attribute selected from a group consisting of: a rating, a play count, a title, an association with a collection, and a playlist designation; and wherein determining additional audio files or metadata to request from the remote source is based at least in part on the attributes associated therewith.

41. The computer program product of claim 40, wherein determining additional audio files to request from the remote source comprises selecting one or more additional audio files that have a highest rating.

42. The computer program product of claim 40, wherein determining additional audio files to request from the remote source comprises selecting one or more additional audio files that have a highest frequency of play.

43. The computer program product of claim 40, wherein the audio files are part of an ordered collection, and determining additional audio files to request from the remote source is based at least in part on comparing the proximity of one or more of the additional audio files in the collection to one or more accessed audio files.

44. The computer program product of claim 40, wherein the audio files are part of a playlist, and determining additional audio files to request from the remote source comprises selecting additional audio files from the playlist that are adjacent to one or more accessed audio files.

45. A device for intelligently retrieving data from a remote source, the device comprising:
a transceiver for request and receiving data and metadata from a remote source;
a metadata store adapted to interface with the transceiver for storing received metadata;
a data cache adapted to interface with the transceiver for storing received data, the data cache further adapted to interface with the metadata store;
an application adapted to be executed on the device and to access data stored in the data cache and metadata store in the metadata store, the application configured to identify additional data or metadata to request from the remote source based on data or metadata accessed thereby, the application further configured to transmit a request for the identified data or metadata using the transceiver.

46. A system for intelligently retrieving data from a remote source, the system comprising:
the device of claim 45, wherein the device is a portable communication device; and
a remote source for communicating with the device, the remote source configured to store data and to transmit data to the device responsive to a request therefor.

47. The system of claim 46, wherein the metadata store is configured to store metadata recently received from the remote source.

48. The system of claim 46, wherein the metadata store is configured to store a selected item of metadata indefinitely.

49. The system of claim 46, wherein the device further comprises:
a data cache configured to store data received from the remote source.

50. The system of claim 46, wherein the data cache is configured to store a selected item of data indefinitely.

51. The system of claim 46, wherein the application is further configured to cancel a request for the identified data or metadata based on a change in the accessed data or metadata.
